(19) United States
(12) Patent Application Publication
(10) Pub. No.: US 2018/0059894 A1
(43) Pub. Date: Mar. 1, 2018

(54) ANSWER PROVIDING METHOD AND ELECTRONIC DEVICE SUPPORTING THE SAME

(71) Applicant: Samsung Electronics Co., Ltd., Gyeonggi-do (KR)

(72) Inventor: Pil Won Kim, Seoul (KR)

(73) Assignee: Samsung Electronics Co., Ltd.

(21) Appl. No.: 15/690,982

(22) Filed: Aug. 30, 2017

(30) Foreign Application Priority Data
Aug. 30, 2016 (KR) 10-2016-0111124

(51) Int. Cl. G06F 3/0484; G06F 17/30; G06F 3/0482; H04L 12/58

(52) U.S. Cl. CPC G06F 3/0484; G06F 17/30864; G06F 3/0488; G06F 3/0482; H04L 51/02; G06F 17/30554

(57) ABSTRACT

An electronic device and a method of providing an answer by the electronic device are provided. The electronic device includes a communication interface configured to communicate with an external electronic device, a memory configured to store a plurality of answers, a display, an input interface configured to acquire a user input, and a processor operatively connected to the communication interface, the memory, the display, and the input interface, wherein the memory is configured to store instructions that, when executed, cause the processor to receive a message from the external electronic device through the communication interface, analyze the received message, select at least one of the plurality of answers according to a type of a keyword included in the received message or context of the received message, output the at least one of the plurality of answers on the display, and change a portion of a first answer of the at least one of the plurality answers if a first user input is acquired through the input interface.

### PRIORITY

This application claims priority under 35 U.S.C. §119(a) to a Korean Patent Application filed on Aug. 30, 2016 in the Korean Intellectual Property Office and assigned Serial number 10-2016-0111124, the entire disclosure of which is incorporated herein by reference.

### BACKGROUND

### 1. Field of the Disclosure

The present disclosure relates generally to a method of providing an answer and an electronic device supporting the same, and more particularly, to a method of changing a portion of an answer and an electronic device supporting the same.

### 2. Description of the Related Art

As wireless communication technology is rapidly developed, development has been actively performed on applications for supporting a function of transceiving a message with an external electronic device through a communication interface. The applications for supporting the above function may include, for example, a short message service (SMS)/multimedia messaging service (MMS) application, an e-mail application, an application for supporting a social network service.

In addition, an electronic device, in which applications are installed, may provide an answer recommending function to allow a user to more rapidly answer a received message. For example, if the electronic device receives a message from an external electronic device, the electronic device may recommend an answer appropriate to the received message.

However, a conventional electronic device fails to provide a function of changing a recommended answer. Accordingly, if there is no answer, which is desired by a user, among recommended answers, the user has to personally input a desired answer.

### SUMMARY

Aspects of the present disclosure are to address at least the above mentioned problems and/or disadvantages and to provide at least the advantages described below. Accordingly, an aspect of the present disclosure is to provide a method capable of changing a portion of a recommended answer and an electronic device supporting the same.

Another aspect of the present disclosure provides a method capable of changing a portion of a recommended answer, thereby supporting a user such that the user more rapidly and conveniently sends a desired answer.

In accordance with an aspect of the present disclosure, an electronic device is provided. The electronic device includes a communication interface configured to communicate with an external electronic device, a memory configured to store a plurality of answers, a display, an input interface configured to acquire a user input, and a processor operatively connected to the communication interface, the memory, the display, and the input interface, wherein the memory is configured to store instructions that, when executed, cause the processor to receive a message from the external electronic device through the communication interface, analyze the received message, select at least one of the plurality of answers according to a type of a keyword included in the received message or context of the received message, output the at least one of the plurality of answers on the display, and change a portion of a first answer of the at least one of the plurality of answers if a first user input is acquired through the input interface.

In accordance with another aspect of the present disclosure, a method of providing an answer by an electronic device including a memory storing a plurality of answers is provided. The method includes receiving a message from an external electronic device connected to the electronic device through a communication interface, analyzing the received message, selecting at least one of the plurality of answers according to a type of a keyword included in the received message or context of the received message, outputting the at least one of the plurality of answers on a display included in the electronic device, acquiring a first user input through an input interface included in the electronic device, and changing a portion of a first answer of the at least one of the plurality of answers in response to the first user input.

### BRIEF DESCRIPTION OF THE DRAWINGS

The above and other aspects, features, and advantages of the present disclosure will be more apparent from the following description, taken in conjunction with the accompanying drawings, in which:

FIG. 1 is a block diagram of an electronic device related to answer providing, according to an embodiment of the present disclosure;

FIG. 2 is an illustration of a wearable electronic device supporting an answering providing method according to an embodiment of the present disclosure;

FIG. 3 is a flowchart of a method of an electronic device related to answer providing, according to an embodiment of the present disclosure;

FIG. 4 is an illustration of a screen of an electronic device related to answer providing, according to an embodiment of the present disclosure;

FIG. 5 is an illustration of an answer providing screen, according to an embodiment of the present disclosure;

FIG. 6 is an illustration of a change of an answer including a date, according to an embodiment of the present disclosure;

FIG. 7 is an illustration of a change of an answer including a date, according to an embodiment of the present disclosure;

FIG. 8 is an illustration of a change of an answer including a location, according to an embodiment of the present disclosure;

FIG. 9 is a block diagram of an electronic device in a network environment according to an embodiment of the present disclosure;

FIG. 10 is a block diagram of an electronic device according to an embodiment of the present disclosure; and

FIG. 11 is a block diagram of a program module according to an embodiment of the present disclosure.

### DETAILED DESCRIPTION OF EMBODIMENTS OF THE PRESENT DISCLOSURE

Hereinafter, various embodiments of the present disclosure are disclosed with reference to the accompanying drawings. However, the present disclosure is not intended to be limited by the various embodiments of the present disclosure to a certain embodiment, but it is intended that the present disclosure covers all modifications, equivalents, and/or alternatives of the present disclosure within the scope of the appended claims and their equivalents. With respect to the descriptions of the accompanying drawings, like reference numerals refer to like elements.

The terms used in the following description and claims are not limited to their dictionary meanings, but, are merely used to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural forms unless the context clearly indicates otherwise. Thus, for example, a reference to “a component surface” includes a reference to one or more such surfaces.

The terms “include,” “comprise,” and “have”, or “may include,” or “may comprise” and “may have” used herein indicate disclosed functions, operations, or the existence of elements but does not exclude other functions, operations or elements.

For example, the expressions “A or B” and “at least one of A and/or B” may indicate A and B, A, or B. For instance, the expressions “A or B” and “at least one of A and/or B” may indicate (1) at least one A, (2) at least one B, and (3) both at least one A and at least one B.

The terms such as “1st,” “2nd,” “first,” “second,” and the like used herein may refer to modifying various different elements of various embodiments of the present disclosure, but are not intended to limit the elements. For instance, “a first user device” and “a second user device” may indicate different users regardless of order or importance. For example, a first component may be referred to as a second component and vice versa without departing from the scope and spirit of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed by” another component (for example, a second component), another component (for example, a third component) does not exist between the component (for example, the first component) and the other component (for example, the second component).

The expression “configured to” used in the present disclosure may be interchangeably used with the expressions “suitable for,” “having the capacity to,” “designed to,” “adapted to,” “made to,” and “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

Terms used in various embodiments of the present disclosure are used to describe certain embodiments of the present disclosure, but are not intended to limit the scope of the present disclosure. The terms of a singular form may include plural forms unless they have a clearly different meaning in the context. Otherwise, all terms used herein may have the same meanings that are generally understood by a person skilled in the art. In general, terms defined in a dictionary should be considered to have the same meanings as the contextual meanings of the related art, and unless clearly defined herein, should not be understood differently or as having an excessively formal meaning. In any case, even the terms defined in the present disclosure are not intended to be interpreted as excluding embodiments of the present disclosure.

An electronic device according to an embodiment of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a motion picture experts group (MPEG-1 or MPEG-2) audio layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit).

In an embodiment of the present disclosure, an electronic device may be a home appliance. A smart home appliance may include at least one of, for example, a television (TV), a digital video/versatile disc (DVD) player, an audio player, a refrigerator, an air conditioner, a cleaner, an oven, a microwave oven, a washing machine, an air cleaner, a set-top box, a home automation control panel, a security control panel, a television (TV) box (e.g., Samsung HomeSync®, Apple TV®, or Google TV™), a game console (e.g., Xbox® or PlayStation®), an electronic dictionary, an electronic key, a camcorder, or an electronic picture frame.

In an embodiment of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA) device, a magnetic resonance imaging (MRI) device, a computed tomography (CT) device, a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automated teller machine (ATM), a point of sales (POS) device of a store, or an Internet of Things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to an embodiment of the present disclosure, an electronic device may include at least one of a part of furniture or a building/structure, an electronic board, an electronic signature receiving device, a projector, and a measuring instrument (e.g., a water meter, an electricity meter, a gas meter, a wave meter, and the like). An electronic device may be one or more combinations of the above-mentioned devices. An electronic device according may be a flexible device. An electronic device is not limited to the above-mentioned devices, but may include newly developed electronic devices.

Hereinafter, an electronic device according to various embodiments of the present disclosure are described in more detail with reference to the accompanying drawings. The term “user” used herein may refer to a person who uses an electronic device or may refer to a device (e.g., an artificial intelligence electronic device) that uses an electronic device.

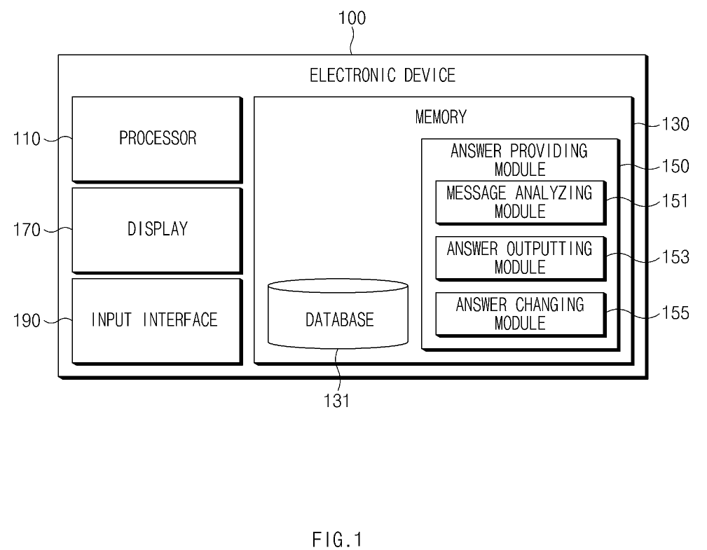

FIG. 1 is a block diagram of an electronic device 100 related to answer providing, according to an embodiment of the present disclosure.

According to an embodiment of the present disclosure, if a message is received, the electronic device 100 may support an automatic answering function such that a user of the electronic device 100 need not personally input an individual answer (or “response” or “replay”) to a received message. For example, the electronic device 100 may analyze the content of the received message, select an answer corresponding to a keyword included in the received message, and output the answer on a screen of a display 170. In addition, the electronic device 100 may provide an interface for a user such that the user may correct the answer, if the user is not satisfied with the selected answer.

Referring to FIG. 1, the electronic device 100 supporting the above functions may include a processor 110, a memory 130, a display 170, and an input interface 190. However, the elements of the electronic device 100 are not limited thereto. According to an embodiment of the present disclosure, the electronic device 100 may exclude at least one element from the above elements and may further include at least another element. For example, the electronic device 100 may further include a communication interface to receive a message from an external electronic device. The communication interface may configure the communication between the electronic device 100 and the external electronic device. For example, the communication interface may be connected to a network through wireless communication or wired communication to establish communication with the external electronic device.

The processor 110 may control at least one of the other elements of the electronic device 100 and/or may perform a computation or data processing related to communication. The processor 110 may load an instruction or data received from at least one of the other elements (e.g., a non-volatile memory) into a volatile memory and may process the instruction or the data. In addition, the processor 110 may store various data into the non-volatile memory. For example, the processor 110 may load an instruction, which is related to an answer providing module 150 and stored in the memory 130, or data, which is stored in a database 131, into the volatile memory and may process the instruction or the data according to a routine of a certain program.

The memory 130 may store an instruction or data related to at least one of the other elements of the electronic device 100. For example, the memory 130 may store software and/or a program. For example, the memory 130 may store the answer providing module 150 related to an answer providing function. Alternatively, the memory 130 may store the database 131 which contains content used in the software and/or the program stored in the memory 130 or various answer data.

The answer providing module 150 may include at least one instruction related to providing an answer. For example, the answer providing module 150 may include an instruction of analyzing a received message, an instruction of selecting an answer from the database 131 according to the content or context of the received message, an instruction of outputting the selected answer onto the display 170, an instruction of changing a portion of the answer corresponding to a certain user input, and an instruction of transmitting the answer to the external electronic device.

The answer providing module 150 may include a message analyzing module 151, an answer outputting module 153, and an answer changing module 155. The message analyzing module 151 may include a first instruction of analyzing the received message. The first instruction may include, for example, an instruction of extracting a keyword from the content of the received message, an instruction of determining a type of the keyword, and an instruction of detecting a context of the received message. For example, the first instruction may include an instruction of determining a word requiring an answer to the received message and of designating the word as a keyword. For example, the word requiring the answer may include, for example, “who”, “what”, “where”, “when”, “why”, and “how” corresponding to the “Five Ws and one H”. Alternatively, the first instruction may include an instruction of determining the form of a sentence in the received message and of determining whether the form of the sentence is declarative, interrogative, exclamative, imperative, or propositive.

The message analyzing module 151 may include a second instruction of selecting at least one answer from the database 131 according to the keyword or the form of the sentence in the received message. The second instruction may include, for example, an instruction of selecting at least one answer, which corresponds to the type of the keyword, from the database 131 or an instruction of forming the selected answer to correspond to the form of the sentence in the selected message. For example, the second instruction may include an instruction of selecting an answer including a time from answers stored in the database 131, in a case where the keyword includes the concept of time, such as “when”, and of selecting a declarative, interrogative, or propositive answer among the selected answers or of forming the selected answer as a declarative, interrogative, or propositive answer in a case where the form of the sentence in the received message is interrogative.

The answer outputting module 153 may include a third instruction of outputting at least one answer, which is selected or formed by the second instruction, on the display 170. The third instruction may include an instruction of variously setting a size of an object (e.g., a size of a font) included in the answer or of variously arranging the answer, depending on the size and the shape of the screen of the display 170 or the type of the input interface 190. For example, the third instruction may include an instruction of setting the size of the object included in the answer to be smaller as the size of the screen of the display 170 is reduced. Alternatively, the third instruction may include an instruction of setting the number of answers, which are to be output on the display 170, to be smaller as the size of the screen of the display 170 is reduced, and of outputting an additional answer in a manner, such as scrolling, performed by a certain user input.

The answer outputting module 153 may include a fourth instruction of highlighting (or focusing) a portion of the answer output on the display 170. The fourth instruction may include, for example, an instruction of highlighting some changeable words included in the answer. The changeable words may include, for example, a time, a date, a day of the week, a location (or a place), a postposition, and an ending. According to an embodiment of the present disclosure, the fourth instruction may include an instruction of highlighting a word, which is first output in a case where a plurality of changeable words are included in the answer, highlighting a word at an uppermost layer or a lowermost layer in a case where the changeable words have a hierarchical structure, for example, in a case where the changeable words include a year, a month, and a day like a date, or of selecting and highlighting one of a plurality of words according to the context of the received message.

The answer changing module 155 may include a fifth instruction of changing a portion of a highlighted (or focused) answer among answers output on the display 170 if a certain user input occurs. The fifth instruction may include, for example, an instruction of changing the portion of the highlighted answer to another changeable word. For example, the fifth instruction may include an instruction of, in a case where a portion of the highlighted answer includes a month of a date, changing the month to a different month selected in the range of January to December. The scheme of changing a portion of the answer is described in greater detail below.

The display 170 may display various contents for a user. For example, the display 170 may output a screen including an answer selected or formed through the answer providing module 150. Alternatively, the display 170 may output the highlighted (or focused) portion of the answer on the screen in a manner different from that of other portions of the answer. For example, the display 170 may output the highlighted portion of the answer with background color or a boundary different from that of the other portions. In addition, if there occurs a user input for selecting or changing the highlighted portion of the answer, the display 170 may output another changeable word on the screen. A scheme of outputting the other changeable word on the screen is described in greater detail below.

The input interface 190 may support a user such that the user selects a portion of an answer output on the display 170, changes the selected portion (e.g., a highlighted portion) to a different portion, or changes the selected portion to a different portion. For example, the input interface 190 may provide an interface that is capable of receiving a certain input from a user.

According to an embodiment of the present disclosure, the input interface 190 may include a touch panel, which is stacked on the display 170 or integrated with the display 170, a bezel, which serves as a portion of a housing of the electronic device 100 and surrounds the display 170, or a physical key which is disposed in the housing of the electronic device 100. In a case where the electronic device 100 is a wearable device such as a smart watch, the input interface 190 may include an input device such as a stem.

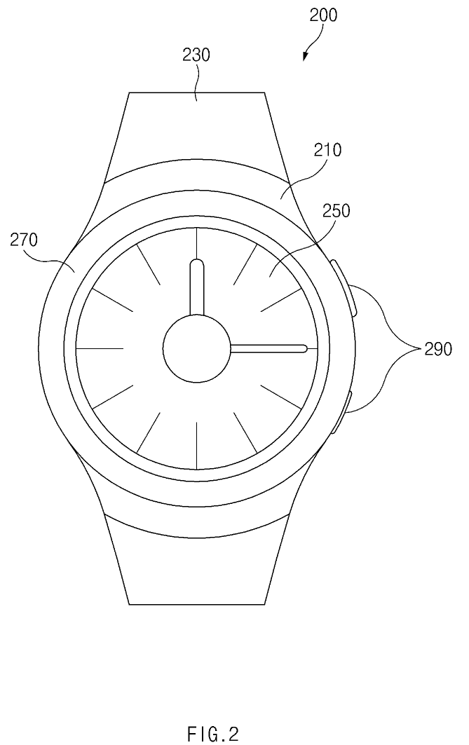

FIG. 2 is an illustration of a wearable electronic device supporting an answering providing method according to an embodiment of the present disclosure. A wearable electronic device 200 illustrated in FIG. 2 may represent one form of the electronic device 100 illustrated in FIG. 1. It should be understood by those skilled in the art that the electronic device 100 illustrated in FIG. 1 is not implemented only in the form of the wearable electronic device 200 of FIG. 2. For example, the electronic device 100 illustrated in FIG. 1 may be implemented in the form of an electronic device such as a smartphone.

Referring to FIG. 2, the wearable electronic device 200 may include a housing 210, a wearing unit 230, and a display 250. The housing 210 may form an outer appearance of the wearable electronic device 200. The housing 210 may include a front surface, a rear surface, and a side surface which surrounds at least a portion of a space between the front surface and the rear surface. The housing 210 may fix and support internal elements of the wearable electronic device 200. For example, the housing 210 may provide a space, in which the display 250, a bracket, a printed circuit board, or a battery is able to be seated, and may fix and support the seated elements.

For example, the bracket may support and fix the display 250, the printed circuit board, or the like when the display 250, the printed circuit board, or the like is seated inside the housing 210. The bracket may include a portion applied with an adhesive material, or an adhesive layer to fix the display 250, the printed circuit board, or the like.

Various electronic components may be mounted on the printed circuit board. For example, at least one electronic device, at least one circuit line, or the like may be mounted on the printed circuit board and may be electrically connected to each other in at least portions. The electronic components may include, for example, a processor, a memory, a communication module (e.g., a communication circuit), or the like.

A battery may supply power to the wearable electronic device 200. For example, the battery may be electrically connected to the printed circuit board to supply power to the electronic components mounted on the printed circuit board. According to an embodiment of the present disclosure, the battery may be provided integrally with the wearable electronic device 200 or detachably from the wearable electronic device 200.

According to an embodiment of the present disclosure, the housing 210 may be provided in various shapes such as a cylindrical shape and a hexahedral shape. For example, the front surface or the rear surface of the housing 210 may be provided in the circular shape, a rectangular shape, or the like.

According to an embodiment of the present disclosure, a front cover may be provided on the front surface of the housing 210. The front cover may form, for example, an outer appearance of the front surface of the wearable electronic device 200. The front cover may be coupled to the housing 210, in a form that the front cover is disposed on the display 250 to cover the display 250. At least a partial area of the front cover may be formed of a transparent material (e.g., glass). Accordingly, the screen output on the display 250 may be viewed from the outside through a transparent area of the front cover.

According to an embodiment of the present disclosure, the housing 210 may include a bezel 270 which surrounds the display 250. For example, the bezel 270 may be provided to surround the boundary of an area (e.g., a front area) of the display 250, wherein the area is exposed through the front surface of the housing 210. The bezel 270 may include a rotating member such as a wheel in a partial area thereof. The rotating member may be electrically connected to the printed circuit board and may transmit an electrical signal, which is generated according to the rotation of the rotating member, to the printed circuit board.

According to an embodiment of the present disclosure, a physical key 290 may be disposed in the housing 210. Although FIG. 2 illustrates that the physical key 290 is disposed on the side surface of the housing 210, the present disclosure is not limited thereto. The physical key 290 may be disposed on the front surface or the rear surface of the housing 210. The physical key 290 may be electrically connected to the printed circuit board to transmit an electrical signal, which is generated by a certain operation (e.g., pressing) involving the physical key 290, to the printed circuit board.

An input device, such as a stem, may be further disposed in the housing 210. For example, the stem may be disposed on the side surface of the housing 210. The stem may be electrically connected to the printed circuit board and may transmit an electrical signal, which is generated according to the rotation of the stem, to the printed circuit board.

The wearing unit 230 may attach to a user such that the user is able to wear the wearable electronic device 200. According to an embodiment of the present disclosure, the wearing unit 230 may be provided in the form of a band. For example, the wearing unit 230 may be provided in such a manner that one side of the wearing unit 230 extends from one side of the housing 210, an opposite side of the wearing unit 230, which is physically apart from the one side of the wearing unit 230, extends from an opposite side of the housing 210, and the extending distal ends of the wearing unit 230 are coupled to each other.

According to an embodiment of the present disclosure, the wearing unit 230 may include a length adjustment unit to adjust the wearing length of the wearing unit 230 according to a circumference of a wrist of a user. The length adjustment unit may include, for example, a plurality of grooves, a hook engaged with the grooves, a tape such as Velcro®, or a magnetic substance such as a magnet.

The display 250 may be disposed inside the housing 210, and a partial area of the display 250 may be exposed through the front surface of the housing 210. The shape of the display 250 may be provided in a shape that is the same as or similar to that of the housing 210. For example, in a case where the front surface or the rear surface of the housing 210 is provided in a circular shape, the display 250 may be provided in a circular shape. However, the shape of the display 250 is not limited thereto. According to an embodiment of the present disclosure, even if the housing 210 is provided in a circular shape, the display 250 may be provided in a rectangular shape.

According to an embodiment of the present disclosure, the display 250 may include a touch screen and may receive, for example, a touch input, a gesture input, a proximity input, and a hovering input by using an electronic pen or a part of the body of a user. For example, in the case of the display 250, a panel included in the display 250 may be provided integrally with a touch panel. The panel of the display 250 may be provided in a stack form together with the touch panel.

The input interface 190 illustrated in FIG. 1 may include at least one of a rotating member included in the bezel 270 of FIG. 2, the physical key 290 or the stem disposed in the housing 210, and the touch panel included in the display 250.

As described above, according to an embodiment of the present disclosure, an electronic device may include a communication interface configured to communicate with an external electronic device, a memory configured to store a plurality of answers, a display, an input interface configured to acquire a user input, and a processor operatively connected to the communication interface, the memory, the display, and the input interface. The memory may store instructions that, when executed, cause the processor to receive a message from the external electronic device through the communication interface, analyze the received message, select at least one of the answers according to a type of a keyword included in the received message or context of the received message, output the at least one of the answers on the display, and change a portion of a first answer of the at least one of the answers if a first user input is acquired through the input interface.

According to an embodiment of the present disclosure, the input interface may include at least one of a rotating member included in a bezel disposed in a portion of a housing of the electronic device, a stem disposed in the housing, a physical key disposed in the housing, and a touch panel included in the display.

According to an embodiment of the present disclosure, the first user input may occur by at least one of an operation of rotating the rotating member, pressing the physical key, rotating the stem, pressing the stem, and touching the display.

According to an embodiment of the present disclosure, the memory may store instructions that, when executed, cause the processor to change the portion of the first answer differently based on at least one of a rotation amount of the rotating member, a number of times that the physical key is pressed, a rotation amount of the stem, a number of times that the stem is pressed, and touch information of the display.

According to an embodiment of the present disclosure, the memory may store instructions that, when executed, cause the processor to determine at least one changeable portion of the first answer, highlight the portion of the first answer, wherein the portion is a portion of the at least one changeable portion, and change the highlighted portion in response to the first user input.

According to an embodiment of the present disclosure, the memory may store instructions that, when executed, cause the processor to output the highlighted portion differently from another portion of the first answer in a manner of applying a graphical effect to the highlighted portion when outputting the first answer on the display.

According to an embodiment of the present disclosure, the memory may store instructions that, when executed, cause the processor to release highlighting of the highlighted portion if a second user input is acquired through the input interface, and highlight another portion of the at least one changeable portion or highlight a portion of a second answer, which is different from the first answer, of the at least one of the answers.

According to an embodiment of the present disclosure, the at least one changeable portion may include at least one of a word indicating time, a word indicating a date, a word indicating a day, a word indicating a location, a postposition, and an ending.

According to an embodiment of the present disclosure, the memory may store instructions that, when executed, cause the processor to change at least one of the answers stored in the memory if a second user input is acquired through the input interface.

According to an embodiment of the present disclosure, the memory may store instructions that, when executed, cause the processor to transmit the first answer to the external electronic device through the communication interface.

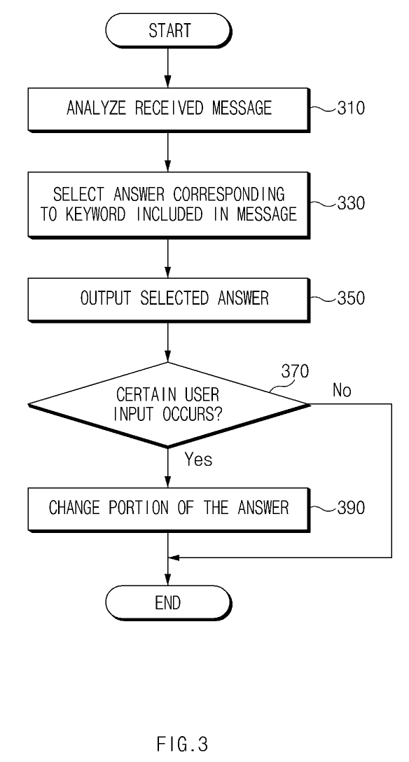

FIG. 3 is a flowchart of an operating method of an electronic device related to answer providing, according to an embodiment of the present disclosure.

Referring to FIG. 3, an electronic device 100 may analyze a received message in step 310. If the electronic device receives a message from an external electronic device through a message application, a mail application, or an application for supporting a social network service (SNS), the electronic device may analyze the received message.

According to an embodiment of the present disclosure, the electronic device may extract a keyword from the content of the received message and may determine a type of the extracted keyword. In addition, the electronic device may detect the context of the received message. For example, the electronic device may determine whether the received message includes a word requiring an answer and may designate the word as a keyword. For example, the word requiring the answer may include, for example, words corresponding to “who”, “what”, “where”, “when”, “why”, and “how”. Alternatively, the electronic device may determine the form of a sentence in the received message, among declarative, interrogative, exclamative, imperative, and propositive forms.

In step 330, the electronic device may select an answer corresponding to the keyword included in the received message. According to an embodiment of the present disclosure, the electronic device may select at least one answer from a database 131 according to the type of the keyword included in the received message. For example, in a case where the keyword includes a concept of time, such as “when”, the electronic device may select an answer including time information from the answers stored in the database.

According to an embodiment of the present disclosure, the electronic device may select some answers selected according to the context of the received message. For example, the electronic device may select a declarative, interrogative, or propositive answer among the selected answers in a case where the form of the sentence in the received message is interrogative. The electronic device may change the selected answers according to the context of the received message. In detail, the electronic device may change the selected answers corresponding to the form of a sentence in the received message. For example, the electronic device may change the selected answers to declarative, interrogative, or propositive answers in a case where the form of the sentence in the received message is interrogative.

In step 350, the electronic device may output the selected answers. For example, the electronic device may output at least one answer, which is selected or formed (or changed) in step 330, on the display 170. According to an embodiment of the present disclosure, the electronic device may variously set a size of an object (e.g., a size of a font) included in the selected answer or variously arrange the selected answer, depending on the size and the shape of the screen of the display or the type of an input interface 190.

According to an embodiment of the present disclosure, the electronic device may set the size of the object included in the selected answer to be smaller as the size of the screen of the display is reduced. Alternatively, the electronic device may set the number of answers, which are to be output on the display, to be fewer as the size of the screen of the display is reduced. In this case, the electronic device may output an additional answer on the display in a manner, such as scrolling, performed by a certain user input.

According to an embodiment of the present disclosure, the electronic device may highlight a portion of the answer output on the display. For example, the electronic device may select one of answers output on the display and may highlight some changeable words included in the selected answer. The changeable words may include, for example, a time, a date, a day of the week, a location, a postposition, and an ending.

According to an embodiment of the present disclosure, the electronic device may highlight a word, which is first output in a case where a plurality of changeable words are included in the selected answer, may highlight a word at an uppermost layer or a lowermost layer, in a case where the changeable words have a hierarchical structure, for example, in a case where the changeable words include a year, a month, and a day like a date, or may select and highlight one of a plurality of words according to the context of the received message.

According to an embodiment of the present disclosure, the electronic device may output the highlighted portion of the answer in a manner different from that of other portions of the answer. The electronic device may output the highlighted portion of the answer with background color or a boundary different from those of the other portions.

In step 370, the electronic device may determine whether a certain user input occurs. For example, the electronic device may determine whether the certain user input occurs through the input interface 190. For example, the input interface may include at least one of a rotating member included in a bezel 270 of the electronic device, a physical key 290 or a stem disposed in the housing 210 of the electronic device, and a touch panel included in the display.

According to an embodiment of the present disclosure, the electronic device may determine whether the rotating member has been rotated, the physical key has been pressed, the stem has been rotated or pressed, or the display has been touched. The electronic device may determine a rotation amount of the rotating member, the number of times that the physical key is pressed, a rotation amount of the stem, the number of times that the stem is pressed, or the touch information of the display (e.g., a touch location, a touch direction, a touch distance, or the number of times that the display is touched).

If the certain user input occurs, the electronic device may change a highlighted portion of the answer output on the display in step 390. For example, the electronic device may change the highlighted portion of the answer to another changeable word. The changeable word may include a word in a type that is the same as or similar to the type of the highlighted portion of the answer. For example, in a case where a highlighted portion of an answer includes a month of a date, another changeable word may include a month in the range of January to December.

According to an embodiment of the present disclosure, the electronic device may select one of the other changeable words to change the highlighted portion of the answer to the selected changeable word, based on a rotation amount of the rotating member, the number of times that the physical key is pressed, a rotation amount of the stem, the number of times that the stem is pressed, or the touch information of the display (e.g., a touch location, a touch direction, a touch distance, or the number of times that the display is touched).

According to an embodiment of the present disclosure, the electronic device may highlight another answer instead of a currently highlighted answer among the answers output on the display corresponding to the certain user input or may highlight another portion instead of a currently highlighted portion of an answer. In addition, the electronic device may output other changeable words, which correspond to the certain user input, on the display. For example, the electronic device may output other changeable words, which correspond to the first user input, in a manner such as scrolling. In addition, the electronic device may select one of the changeable words corresponding to the second user input and may change a portion of the highlighted answer to the selected word.

As described above, according to an embodiment of the present disclosure, an answer providing method by an electronic device including a memory storing a plurality of answers may include receiving a message from an external electronic device connected to the electronic device through a communication interface, analyzing the received message, selecting at least one of the answers according to a type of a keyword included in the received message or the context of the received message, outputting the at least one of the answers on a display included in the electronic device, acquiring a first user input through an input interface included in the electronic device, and changing a portion of a first answer of the at least one of the answers in response to the first user input.

According to an embodiment of the present disclosure, the input interface may include at least one of a rotating member included in a bezel disposed in a portion of a housing of the electronic device, a physical key disposed in the housing, a stem disposed in the housing, and a touch panel included in the display.

According to an embodiment of the present disclosure, the first user input may occur by at least one of an operation of rotating the rotating member, pressing the physical key, rotating the stem, pressing the stem, and touching the display.

According to an embodiment of the present disclosure, changing the portion of the first answer may include changing the portion of the first answer differently based on at least one of a rotation amount of the rotating member, a number of times that the physical key is pressed, a rotation amount of the stem, a number of times that the stem is pressed, and touch information of the display.

According to an embodiment of the present disclosure, the answer providing method may further include determining at least one changeable portion of the first answer, and highlighting the portion of the first answer, wherein the portion is a portion of the at least one changeable portion. The changing of the portion of the first answer may include changing the highlighted portion.

According to an embodiment of the present disclosure, outputting the at least one of the answers on the display may include outputting the highlighted portion differently from another portion of the first answer in a manner of applying a graphical effect to the highlighted portion.

According to an embodiment of the present disclosure, the answer providing method may further include releasing highlighting of the highlighted portion if a second user input is acquired through the input interface, and highlighting another portion of the at least one changeable portion or highlighting a portion of a second answer, which is different from the first answer, of the at least one of the answers.

According to an embodiment of the present disclosure, the at least one changeable portion may include at least one of a word indicating time, a word indicating a date, a word indicating a day, a word indicating a location, a postposition, and an ending.

According to an embodiment of the present disclosure, the answer providing method may further include changing at least one of the answers stored in the memory if a second user input is acquired through the input interface.

According to an embodiment of the present disclosure, the answer providing method may further include transmitting the first answer to the external electronic device through the communication interface.

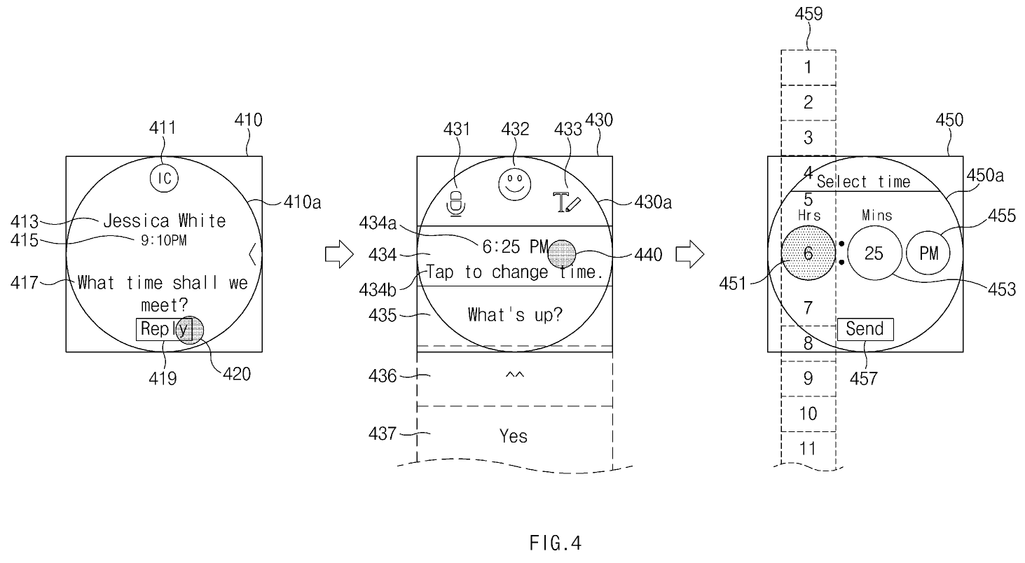

FIG. 4 is an illustration of a screen of an electronic device related to answer providing, according to an embodiment of the present disclosure.

Referring to FIG. 4, if an electronic device 100 receives a message from an external electronic device, the electronic device may output a first screen 410, which includes the received message, on a display 170. According to an embodiment of the present disclosure, the first screen 410 may be variously formed depending on the size and the shape of a screen of the display. For example, in a case where the screen of the display has a rectangular shape, the first screen 410 may be formed in the rectangular shape. Alternatively, in a case where the screen of the display has a circular shape, the first screen 410 may be formed in a circular frame 410a.

For example, the first screen 410 may include an identification image (or an icon) 411 of the received message, calling information (e.g., the name of a caller) 413 of the received message, a reception time 415 of the received message, content 417 of the received message, or an answer button 419 (e.g., “Reply”).

If there is a first user input 420 for selecting the answer button 419, the electronic device may analyze the content 417 of the received message. For example, the electronic device may extract a keyword from the content 417 of the received message and determine the type of the extracted keyword. In addition, the electronic device may detect the context of the content 417 of the received message. For example, as illustrated in FIG. 4, in a case where the content 417 of the received message includes a word, such as “time”, or a phrase including “time” which represents (or indicates) time information, as illustrated in the sentence “What time shall we meet?”, the electronic device may select a time-related answer from a database 131. Further, in a case where the content 417 of the received message includes a sign such as “?”, a word, or a phrase representing an interrogative sentence, the electronic device may select a declarative, interrogative, or propositive answer from the database or may change the selected answer to a declarative, interrogative, or propositive answer.

If at least one answer is selected from the database to correspond to the first user input 420, the electronic device may output a second screen 430, which includes the selected answer, on the display. Similarly to the first screen 410, the second screen 430 may be variously formed depending on the size and the shape of the screen of the display. For example, the second screen 430 may be formed in a circular frame 430a.

The second screen 430 may include a first icon 431, a second icon 432, and a third icon 433 formed to allow a user to select a manner of inputting an answer. The first icon 431, the second icon 432, and the third icon 433 may support a user such that the user inputs an answer in the form of voice, an emoticon (or emoji), and a text (e.g., handwriting). For example, if there is an input for selecting the first icon 431, the electronic device may activate a microphone such that the user inputs the answer in the form of a voice. If there is an input for selecting the second icon 432, the electronic device may output a screen having a plurality of emoticons (emoji) on the display such that the user selects an emoticon (emoji). If there is an input for selecting the third icon 433, the electronic device may output a soft input panel (SIP) on the display such that the user inputs a text (e.g., handwriting).

The second screen 430 may include at least one answer selected from the database in addition to the above-described icons. The electronic device may variously set the size of an object included in the answer or variously arrange the answer, depending on the size and the shape of the screen of the display or the type of an input interface 190. According to an embodiment of the present disclosure, the electronic device may set the size of the object included in the answer to be smaller as the size of the second screen 430 is reduced. In addition, the electronic device may set the number of answers, which are to be output on the second screen 430, to be less as the size of the second screen 430 is reduced. FIG. 4 illustrates a state in which the electronic device arranges a first answer 434 and a second answer 435 on the second screen 430. A third answer 436 or a fourth answer 437, which is another answer selected in addition to the first answer 434 and the second answer 435, may be included in the second screen 430 in a manner, such as scrolling, performed by a certain user input. For example, if there is an input of swiping up on the second screen 430, the electronic device may change at least one of the first answer 434 and the second answer 435 to at least one of the third answer 436 and the fourth answer 437 to form the second screen 430.

According to an embodiment of the present disclosure, if a changeable answer is present among the answers included in the second screen 430, the electronic device may arrange the content of the changeable answer and a notification object on the second screen 430. FIG. 4 illustrates that the electronic device arranges content 434a of the first answer 434 and a notification object 434b on the second screen 430. The changeable answer may include an answer which is formed as the content 434a of the answer includes a time, a date, a day of the week, a location, a postposition, or an ending.

If there is a second user input 440 for selecting the changeable answer, the electronic device may output, on the display, a third screen 450 for supporting a user such that the user changes an answer. Similarly to the first screen 410 and the second screen 430, the third screen 450 may be variously formed depending on the size and the shape of the screen of the display. For example, the third screen 450 may be configured in a circular frame 450a.

The third screen 450 may include content of a changeable answer and a send button 457. FIG. 4 illustrates a state in which the first answer 434 is selected and thus the content 434a of the first answer 434 is arranged on the third screen 450. According to an embodiment of the present disclosure, the electronic device may determine a changeable word included in the selected answer. For example, in a case where a word representing (or indicating) a time is included as illustrated in the first answer 434, the electronic device may determine a word representing (or indicating) an hour, a minute, a second, or “A.M./P.M.” as a changeable word. The changeable word may include, for example, a time, a date, a day of the week, a location, a proposition, or an ending.

According to an embodiment of the present disclosure, the electronic device may highlight some of the changeable words. For example, the electronic device may highlight a word, which is first output in a case where a plurality of changeable words are included in the first answer 434, may highlight a word at an uppermost layer or a lowermost layer, in a case where the changeable words have a hierarchical structure, for example, in a case where the changeable words include an hour, a minute, or a second like a time, or may select and highlight one of a plurality of words according to a context of the received message. FIG. 4 illustrates a state in which the changeable words include a first word 451 representing (or indicating) an hour, a second word 453 representing (or indicating) a minute, and a third word 455 representing (or indicating) “A.M./P.M.”, and the electronic device highlights the first word 451 which is first output among them. The electronic device may output the highlighted portion of the answer in a manner different from that of other portions of the answer. FIG. 4 illustrates that a background color of the first word 451 highlighted by the electronic device is different from those of the second word 453 and the third word 455.

According to an embodiment an embodiment of the present disclosure, if the certain user input occurs, the electronic device may change the highlighted portion of the answer. For example, if the certain user input occurs through the input interface, the electronic device may change the highlighted portion of the answer. The certain user input may occur in a case where the rotating member included in a bezel 270 is rotated, a physical key 290 disposed in a housing 210 is pressed, a stem disposed in the housing is rotated or pressed, or the display is touched.

According to an embodiment of the present disclosure, the electronic device may change the highlighted portion of the answer to a word in the type or the form that is the same as or similar to that of the highlighted portion of the answer. For example, as illustrated in FIG. 4, in a case where the highlighted first word 451 represents (or indicates) an hour, the electronic device may change the first word 451 to a word 459 representing (or indicating) another hour in the range of 0 to 24.

According to an embodiment of the present disclosure, the electronic device may select one of the words, which are included in a changeable range, according to the degree of occurrence of the certain input. For example, the electronic device may select one of the other changeable words to change the highlighted portion of the answer to the selected changeable word, based on a rotation amount of the rotating member, a number of times that the physical key is pressed, a rotation amount of the stem, a number of times that the stem is pressed, or the touch information of the display (e.g., a touch location, a touch direction, a touch distance, or a number of times that the display is touched). For example, in a case where the highlighted first word 451 represents (or indicates) an hour, the electronic device may change the first word 451 to a word representing (or indicating) an hour that is different from the hour represented by the first word 451 according to an increase in the rotation amount of the rotating member, the number of times that the physical key is pressed, the rotation amount of the stem, the number of times that the stem is pressed, the touch distance of the display, or the number of times that the display is touched.

According to an embodiment of the present disclosure, if there is an input for selecting the send button 457, the electronic device may transmit the answer, which is output on the third screen 450, to an external electronic device.

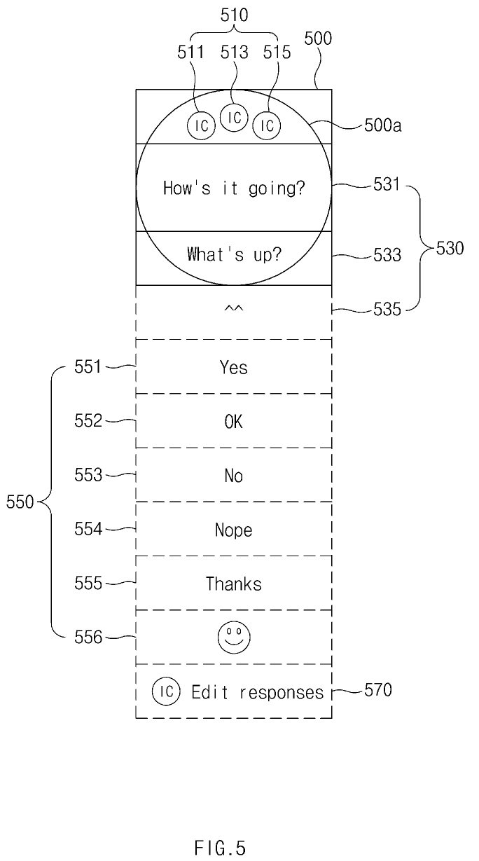

FIG. 5 is an illustration of an answer providing screen, according to an embodiment of the present disclosure.

Referring to FIG. 5, an electronic device 100 may output an answer providing screen 500 on a display 170. The answer providing screen 500 of FIG. 5 may include elements that are the same as or similar to those of the second screen 430 of FIG. 4.

If a button (e.g., the answer button 419 of FIG. 4) for supporting a user is selected such that the user provides an answer to a received message, the electronic device may select at least one answer from a database 131 having a plurality of answers and may output the answer providing screen 500 including the at least one answer, which is selected, on the display. The answer providing screen 500 may be variously formed depending on a size and a shape of a screen of the display. For example, in a case where the screen of the display is formed in a rectangular shape, the answer providing screen 500 may be formed in the rectangular shape. Alternatively, in a case where the screen of the display has a circular shape, the answer providing screen 500 may be formed in a circular frame 500a.

The answer providing screen 500 may include icons 510 formed to allow a user to select a manner of inputting an answer. FIG. 5 illustrates a state in which the answer providing screen 500 includes a first icon 511, a second icon 513, and a third icon 515. The first icon 511, the second icon 513, and the third icon 515 may support the user such that the user inputs an answer in the form of a voice, an emoticon (or emoji), and a text (e.g., handwriting). However, the type or the number of the icons 510 is not limited thereto. According to an embodiment of the present disclosure, the answer providing screen 500 may exclude at least one element from the above icons 510 and may further include at least another element.

The answer providing screen 500 may include at least one answer 530 selected from the database in addition to the above-described icons 510. FIG. 5 illustrates a state in which a first answer 531 and a second answer 533 are arranged on the answer providing screen 500. It can be readily understood by those skilled in the art that the number of answers included in the answer providing screen 500 and the size of an object included in each answer may vary depending on the size and the shape of the screen on the display.

According to an embodiment of the present disclosure, the electronic device may allow the answer providing screen 500 to include other answers (e.g., a third answer 535), which are not included in the answer providing screen 500, among the selected answers 530 in a manner, such as scrolling, performed by a certain user input. For example, if an input of swiping up occurs on the answer providing screen 500, the electronic device may change the first answer 531 or the second answer 533 to the third answer 535 to form the answer providing screen 500.

According to an embodiment of the present disclosure, the electronic device may allow the answer providing screen 500 to include at least one different answer 550 stored in the database in addition to the selected answers 530. Based on an analysis result of the received message, the answers 550, which are used as commonly used phrases in addition to the selected answers 530, may be included in the answer providing screen 500. The answers 550 used as the commonly used phrases may include, for example, a fourth answer 551 including a positive word, a fifth answer 552 including another positive word, a sixth answer 553 including a negative word, a seventh answer 554 including another negative word, an eighth answer 555 including a word related to an expression of gratitude, or a ninth answer 556 including an emoticon for expressing an emotion of the user. However, the types and the number of the answers 550 used as the commonly used phrases are not limited thereto. The answer providing screen 500 may exclude at least one answer from the answers 550 used as the above-described commonly used phrases and may further include at least one answer used as a different commonly-used phrase.

According to an embodiment of the present disclosure, the answers 550 used as the commonly used phrases may be included in the answer providing screen 500 regardless of the content or the context of the received message. In addition, the answers 550 used as the commonly used phrases are not included in the answer providing screen 500 in the state that the answer providing screen 500 is first output. The answers used as the commonly used phrases may be included in the answer providing screen 500 in a manner, such as scrolling, performed by the certain user input. For example, if an input for swiping up occurs on the answer providing screen 500, the electronic device may change some of the selected answers 530 to some of the answers 550 used as the commonly used phrases to form the answer providing screen 500.

According to an embodiment of the present disclosure, the answer providing screen 500 may further include a button 570 (e.g., “Edit responses”) for supporting a user such that the user may correct answers stored in the database or stores an additional answer in the database. For example, if there is an input for selecting the button 570, the electronic device may output the answers, which are stored in the database, on the display, may support a user such that the user selects some of the answers, may support the user such that the user corrects the selected answer, and may support the user such that the user stores the additional answer in the database.

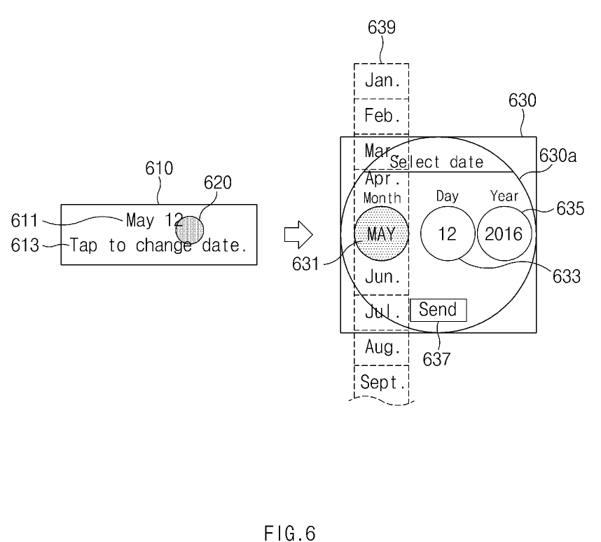

FIG. 6 is an illustration of a change of an answer including a date, according to an embodiment of the present disclosure.

Referring to FIG. 6, an electronic device 100 may select at least one answer from a database 131 having a plurality of answers and may output the at least one answer on a display 170, according to the content or the context of a received message. According to an embodiment of the present disclosure, in a case where a word (e.g., “date”) having a concept of a date is included in the content of the received message, the electronic device may form an answer providing screen (e.g., the answer providing screen 500 of FIG. 5) with an answer 610 representing (or indicating) a date to output the answer providing screen on the display as illustrated in FIG. 6. FIG. 6 illustrates only the answer 610 selected among elements included in the answer providing screen.

The answer 610 representing (or indicating) the date may include a date 611 provided as an answer and a notification object 613 for notifying that the date 611 is changeable. If there is an input 620 for selecting the answer 610 representing the date, the electronic device may output, on the display, an answer changing screen 630 (e.g., the third screen 450 of FIG. 4) for supporting a user such that the user changes the date 611. The answer changing screen 630 may be variously formed depending on a size and a shape of a screen of the display. For example, in a case where the screen of the display is formed in a rectangular shape, the answer changing screen 630 may be formed in the rectangular shape. Alternatively, in a case where the screen of the display has a circular shape, the answer changing screen 630 may be formed in a circular frame 630a.

The answer changing screen 630 may include the date 611 and a send button 637. According to an embodiment of the present disclosure, the answer changing screen 630 may include a first word 631 representing (or indicating) a month of the date 611, a second word 633 representing a day of the date 611, or a third word 635 representing a year of the date 611 as illustrated in FIG. 6. However, the present disclosure is not limited thereto. The answer changing screen 630 may exclude at least one element from the above-described words. For example, the answer changing screen 630 may exclude the third word 635 representing the year. In addition, the arrangement locations of the first word 631, the second word 633, and the third word 635 included in the answer changing screen 630 are not limited to those illustrated in FIG. 6. The third word 635 may be arranged at the left side of the first word 631.

According to an embodiment of the present disclosure, the electronic device may determine a changeable word among words included in the answer changing screen 630. The changeable words may include, for example, a time, a date, a day of the week, a location, a postposition, or an ending.

According to an embodiment of the present disclosure, the electronic device may highlight some of changeable words. The electronic device may highlight a word, which is first output in a case where a plurality of changeable words are included in the answer changing screen 630, may highlight a word at an uppermost layer or a lowermost layer, in a case where the changeable words have a hierarchical structure, for example, in a case where the changeable words include a year, a month, or a day like a date, or may select and highlight one of a plurality of words, according to a context of the received message. FIG. 6 illustrates a state in which the electronic device highlights the first word 631 which is first output among the words. The electronic device may output the highlighted portion of the answer in a manner different from that of other portions of the answer. FIG. 6 illustrates a state in which the electronic device outputs a background color of the highlighted first word 631, which is different from those of the second word 633 and the third word 635.

According to an embodiment of the present disclosure, the electronic device may change a target to be highlighted. For example, if a certain user input occurs, the electronic device may release a highlighted state of the currently highlighted word (e.g., the highlighted state of the first word 631), may select another (e.g., the second word 633 or the third word 635) among the changeable words, and may highlight the selected word.

According to an embodiment of the present disclosure, if a certain user input occurs, the electronic device may change the highlighted portion of the answer. For example, if the certain user input occurs through an input interface 190, the electronic device may change the highlighted portion of the answer. The certain user input may occur in a case where the rotating member included in a bezel 270 is rotated, a physical key 290 disposed in a housing 210 is pressed, a stem disposed in the housing is rotated or pressed, or the display is touched.

According to an embodiment of the present disclosure, the electronic device may change the highlighted portion of an answer to a word in the same or similar type or form as that of the highlighted portion of the answer. For example, as illustrated in FIG. 6, in a case where the highlighted first word 631 represents (or indicates) a month, the electronic device may change the first word 631 to a word 639 representing another month in the range of January to December.

According to an embodiment of the present disclosure, the electronic device may select one of the words, which are included in a changeable range, according to the degree of occurrence of the certain input. For example, the electronic device may select one of the other changeable words to change the highlighted portion of the answer to the selected changeable word, based on a rotation amount of the rotating member, a number of times that the physical key is pressed, a rotation amount of the stem, a number of times that the stem is pressed, or the touch information of the display (e.g., a touch location, a touch direction, a touch distance, or a number of times that the display is touched). For example, in a case where the highlighted first word 631 represents (or indicates) a month, the electronic device may change the first word 631 to a word representing a month that is different from the month represented by the first word 631 according to an increase in the rotation amount of the rotating member, a number of times that the physical key is pressed, a rotation amount of the stem, a number of times that the stem is pressed, a touch distance of the display, or a number of times that the display is touched.

According to an embodiment of the present disclosure, if there is an input for selecting the send button 637, the electronic device may transmit the answer, which is output on the answer changing screen 630, to an external electronic device.

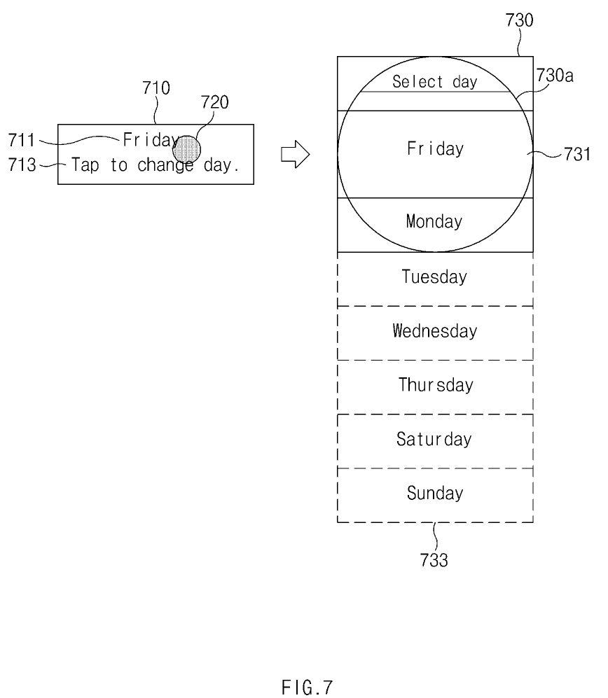

FIG. 7 is an illustration of a change of an answer including a date, according to an embodiment of the present disclosure.

Referring to FIG. 7, the electronic device 100 may select at least one answer from a database 131 having a plurality of answers and may output the at least one answer on a display 170, according to the content or the context of a received message. According to an embodiment of the present disclosure, in a case where a word (e.g., “week” or “day”) having a concept of a day is included in the content of the received message, the electronic device may form an answer providing screen 500 with an answer 710 representing (or indicating) a day to output the answer providing screen on the display as illustrated in FIG. 7. FIG. 7 illustrates only the answer 710 selected among elements included in the answer providing screen.

The answer 710 representing (or indicating) the day may include a day 711 provided as an answer and a notification object 713 for notifying that the day 711 is changeable If there is an input 720 for selecting the answer 710 representing the day, the electronic device may output, on the display, an answer changing screen 730 (e.g., the third screen 450 of FIG. 4) for supporting a user such that the user may change the day 711. The answer changing screen 730 may be variously formed depending on a size and a shape of a screen of the display. For example, in a case where the screen of the display is formed in a rectangular shape, the answer changing screen 730 may be formed in the rectangular shape. Alternatively, in a case where the screen of the display has a circular shape, the answer changing screen 730 may be formed in a circular frame 730a.

The answer changing screen 730 may include a currently selected day 731 and a changeable day 733. According to an embodiment of the present disclosure, the electronic device may form the currently selected day 731 at a center of the answer changing screen 730. Alternatively, the electronic device may form a portion of the changeable day 733 at a lower portion of the currently selected day 731. Although FIG. 7 illustrates that only one changeable day 733 is formed on the answer changing screen 730, it can be readily understood by those skilled in the art that the number of changeable days 733 to be formed in the answer changing screen 730 may vary depending on the size and the shape of the screen of the display.

According to an embodiment an embodiment of the present disclosure, the electronic device may allow the answer changing screen 730 to include another day, which is not included in the answer changing screen 730, among the changeable days 733 in a manner, such as scrolling, performed by the certain user input. For example, if an input of swiping up occurs on the answer changing screen 730, the electronic device may change at least one of the currently selected day 731 and the changeable days 733 included in the answer changing screen 730 to another day, which is not included in the answer changing screen 730, to form the answer changing screen 730.

According to an embodiment of the present disclosure, if a certain user input occurs, the electronic device may change the currently selected day 731 to one of the changeable days 733. For example, if the certain user input occurs through an input interface 190, the electronic device may change the currently selected day 731 to one of the changeable days 733. The certain user input may occur in a case where the rotating member included in a bezel 270 is rotated, a physical key 290 disposed in the housing is pressed, a stem disposed in a housing 210 is rotated or pressed, or the display is touched.

According to an embodiment of the present disclosure, the electronic device may select one of the changeable days 733, which are included in a changeable range, according to the degree of occurrence of the certain input. For example, the electronic device may select one of the changeable days 733 to change the currently selected day 731 to the selected changeable day, based on a rotation amount of the rotating member, a number of times that the physical key is pressed, a rotation amount of the stem, a number of times that the stem is pressed, or the touch information of the display (e.g., a touch location, a touch direction, a touch distance, or a number of times that the display is touched). For example, the electronic device may change the currently selected day 731 to a day that is different from the currently selected day 731 according to the increase in the rotation amount of the rotating member, the number of times that the physical key is pressed, the rotation amount of the stem, the number of times that the stem is pressed the touch distance of the display, or the number of times that the display is touched.

According to an embodiment of the present disclosure, the answer changing screen 730 may further include a send button. If there occurs an input for selecting the send button, the electronic device may transmit the answer, which is output on the answer changing screen 730, to an external electronic device.

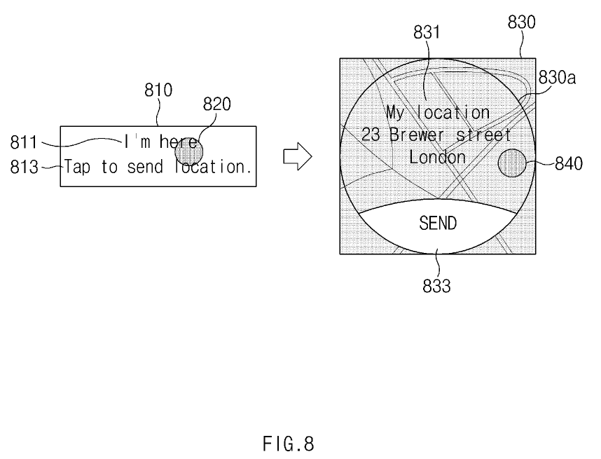

FIG. 8 is an illustration of a change of an answer including a location, according to an embodiment of the present disclosure.

Referring to FIG. 8, the electronic device 100 may select at least one answer from a database 131 having a plurality of answers and may output the at least one answer on a display 170, according to the content or the context of a received message. According to an embodiment of the present disclosure, in a case where a word (e.g., “location” or “where”) including the concept of a location (or a place) is included in the content of the received message, the electronic device may form an answer providing screen 500 with an answer 810 representing (or indicating) a location (or a place) and may output the answer providing screen on the display as illustrated in FIG. 8. FIG. 8 illustrates only the answer 810 selected among elements included in the answer providing screen.

The answer 810 representing (or indicating) the location may include a location 811 provided as an answer and a notification object 813 for notifying that the location 811 is changeable. If there is a user input 820 for selecting the answer 810 representing the location, the electronic device may output, on the display, an answer changing screen 830 (e.g., the third screen 450 of FIG. 4) for supporting a user such that the user may change the location 811. The answer changing screen 830 may be variously formed depending on a size and a shape of a screen of the display. For example, in a case where the screen of the display is formed in a rectangular shape, the answer changing screen 830 may be formed in the rectangular shape. Alternatively, in a case where the screen of the display has a circular shape, the answer changing screen 830 may be formed in a circular frame 830a.

The answer changing screen 830 may include a word 831 representing (or indicating) a currently selected location and a send button 833. According to an embodiment of the present disclosure, the answer changing screen 830 may include a map such that a user may select a location.

According to an embodiment of the present disclosure, the electronic device may change the currently selected location if a certain user input occurs. For example, if the certain user input occurs through an input interface 190, the electronic device may change the currently selected location. For example, the certain user input may occur in a case where the display is touched. For example, if the display is touched, the electronic device may determine a touch location on the display and may determine a point on a map corresponding to the touch location. In addition, the electronic device may acquire the location, which is indicated by the point on the map, from a server managing location information or a database having location information. For example, the electronic device may acquire a place name indicated by the point on the map. After the electronic device acquires location information indicated by the point on the map, the electronic device may change the currently selected location to the relevant location and may change the word 831 representing (or indicating) the currently selected location.

According to an embodiment of the present disclosure, if there is an input for selecting the send button 833, the electronic device may transmit the answer, which is output on the answer changing screen 830, to an external electronic device.

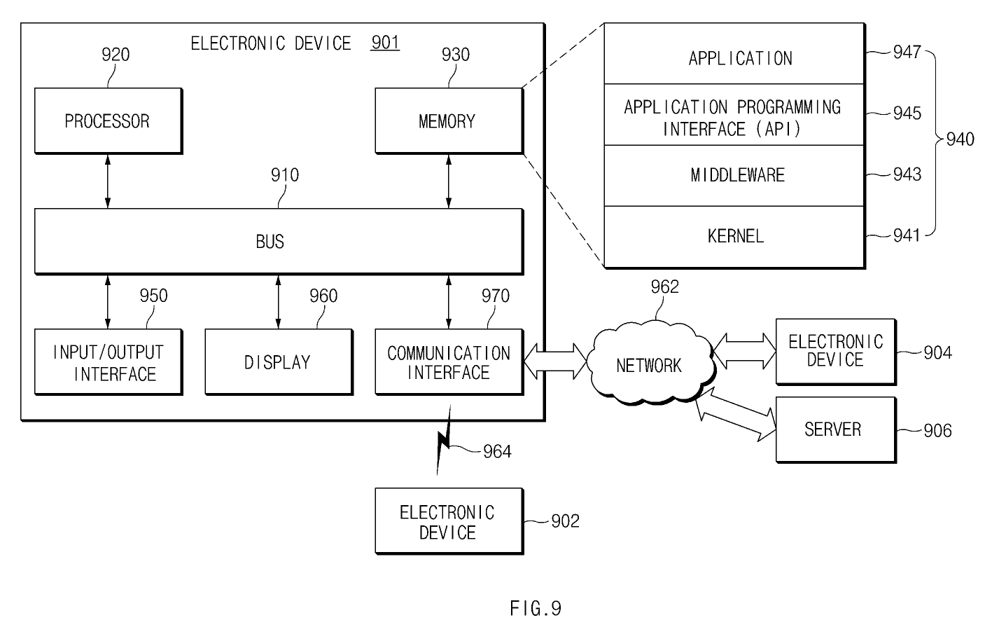

FIG. 9 is a block diagram of an electronic device 901 in a network environment according to an embodiment of the present disclosure.

Referring to FIG. 9, the electronic device 901 in the network environment according to an embodiment of the present disclosure is described below. The electronic device 901 may include a bus 910, a processor 920, a memory 930, an input/output interface 950, a display 960, and a communication interface 970. At least one of the foregoing elements 910 to 970 may be omitted or another element may be added to the electronic device 901.

The bus 910 may include a circuit for connecting the above-mentioned elements 910 to 970 to each other and transferring communications (e.g., control messages and/or data) among the above-mentioned elements 910 to 970.

The processor 920 may include at least one of a CPU, an AP, and a communication processor (CP). The processor 920 may perform data processing, an operation related to communication, and/or control of at least one of the other elements of the electronic device 901.

The memory 930 may include a volatile memory and/or a nonvolatile memory. The memory 930 may store instructions or data related to at least one of the other elements of the electronic device 901. According to an embodiment of the present disclosure, the memory 930 may store software and/or a program 940. The program 940 may include, for example, a kernel 941, middleware 943, an application programming interface (API) 945, and/or an application program (or an application) 947. At least a portion of the kernel 941, the middleware 943, or the API 945 may be referred to as an operating system (OS).

The kernel 941 may control or manage system resources (e.g., the bus 910, the processor 920, the memory 930, and the like) used to perform operations or functions of other programs (e.g., the middleware 943, the API 945, or the application program 947). Furthermore, the kernel 941 may provide an interface for allowing the middleware 943, the API 945, and the application program 947 to access individual elements of the electronic device 901 in order to control or manage the system resources.

The middleware 943 may serve as an intermediary so that the API 945 or the application program 947 may communicate and exchange data with the kernel 941.

Furthermore, the middleware 943 may handle one or more task requests received from the application program 947 according to a priority order. For example, the middleware 943 may assign at least one application program 947 a priority for using the system resources (e.g., the bus 910, the processor 920, the memory 930, and the like) of the electronic device 901. For example, the middleware 943 may handle one or more task requests according to a priority assigned to at least one application, thereby performing scheduling or load balancing with respect to the one or more task requests.

The API 945, which is an interface for allowing the application program 947 to control a function provided by the kernel 941 or the middleware 943, may include, for example, at least one interface or function (e.g., instructions) for file control, window control, image processing, character control, and the like.

The input/output interface 950 may serve to transfer an instruction or data input from a user or another external device to (an)other element(s) of the electronic device 901. Furthermore, the input/output interface 950 may output instructions or data received from (an)other element(s) of the electronic device 901 to the user or another external device.

The display 960 may include, for example, a liquid crystal display (LCD), a light-emitting diode (LED) display, an organic light-emitting diode (OLED) display, a microelectromechanical systems (MEMS) display, or an electronic paper display. The display 960 may present various content (e.g., a text, an image, a video, an icon, a symbol, or the like) to a user. The display 960 may include a touch screen, and may receive a touch, a gesture, a proximity or hovering input from an electronic pen or a part of a body of a user.

The communication interface 970 may establish communication between the electronic device 901 and an external device (e.g., a first external electronic device 902, a second external electronic device 904, or a server 906). For example, the communication interface 970 may be connected to a network 962 via wireless communications or wired communications so as to communicate with the second external electronic device 904 or the server 906.

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM). The wireless communications may include, for example, short-range communications 964. The short-range communications may include at least one of wireless fidelity (Wi-Fi), Bluetooth, near field communication (NFC), magnetic stripe transmission (MST), or GNSS.

The MST may generate pulses according to transmission data and the pulses may generate electromagnetic signals. The electronic device 901 may transmit the electromagnetic signals to a reader device such as a POS device. The POS device may detect the magnetic signals by using an MST reader and restore data by converting the detected electromagnetic signals into electrical signals.

The GNSS may include, for example, at least one of a global positioning system (GPS), a global navigation satellite system (GLONASS), a BeiDou navigation satellite system (BeiDou), or Galileo, the European global satellite-based navigation system according to a use area or a bandwidth. Hereinafter, the terms “GPS” and “GNSS” may be used interchangeably. The wired communications may include at least one of a universal serial bus (USB), a high definition multimedia interface (HDMI), a recommended standard 232 (RS-232), a plain old telephone service (POTS), and the like. The network 962 may include at least one of telecommunications networks, for example, a computer network (e.g., a local area network (LAN) or a wide area network (WAN)), the Internet, or a telephone network.

The types of the first external electronic device 902 and the second external electronic device 904 may be the same as or different from the type of the electronic device 901. According to an embodiment of the present disclosure, the server 906 may include a group of one or more servers. A portion or all of the operations performed in the electronic device 901 may be performed in the first electronic device 902, the second external electronic device 904, or the server 906. When the electronic device 901 is to perform a certain function or service automatically or in response to a request, the electronic device 901 may request at least a portion of functions related to the function or service from the first electronic device 902, the second external electronic device 904, or the server 906 instead of, or in addition to, performing the function or service itself. The first electronic device 902, the second external electronic device 904, or the server 906 may perform the requested function or an additional function, and may transfer a result of performing a function to the electronic device 901. The electronic device 901 may use a received result as is or additionally process the received result to provide the requested function or service. To this end, for example, a cloud computing technology, a distributed computing technology, or a client-server computing technology may be used.

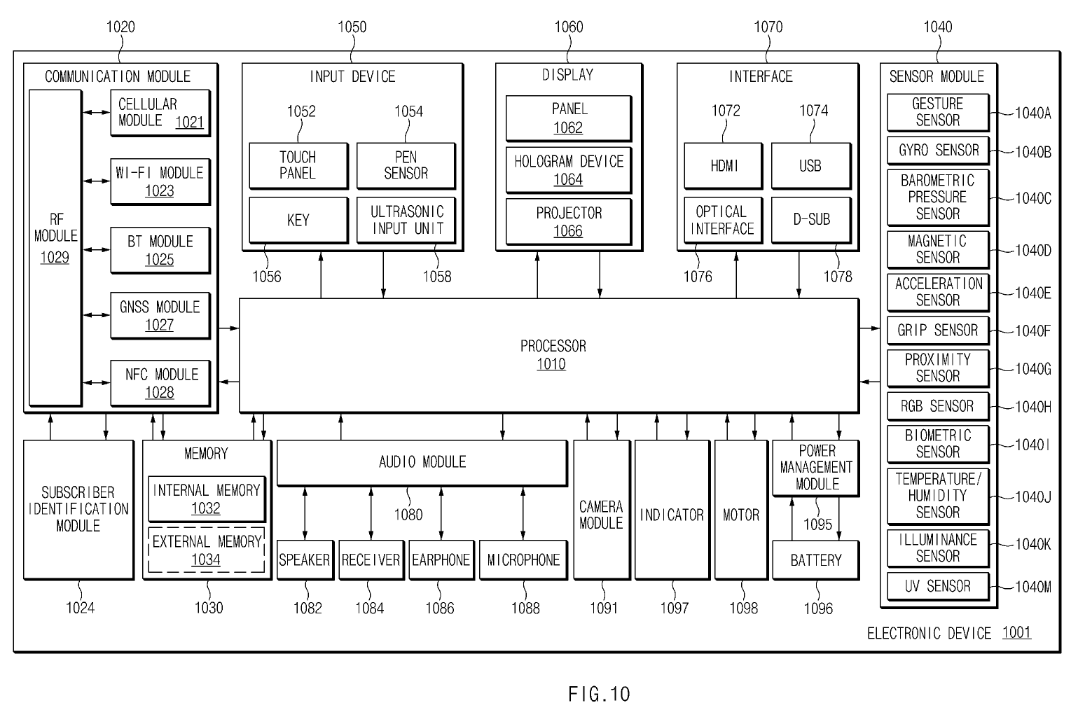

FIG. 10 is a block diagram of an electronic device 1001 according to an embodiment of the present disclosure.

Referring to FIG. 10, the electronic device 1001 may include, for example, a part or an entirety of the electronic device 901 illustrated in FIG. 9. The electronic device 1001 may include at least one processor (e.g., AP) 1010, a communication module 1020, a subscriber identification module (SIM) 1024, a memory 1030, a sensor module 1040, an input device 1050, a display 1060, an interface 1070, an audio module 1080, a camera module 1091, a power management module 1095, a battery 1096, an indicator 1097, and a motor 1098.

The processor 1010 may run an OS or an application program so as to control a plurality of hardware or software elements connected to the processor 1010, and may process various data and perform operations. The processor 1010 may be implemented with, for example, a system on chip (SoC). According to an embodiment of the present disclosure, the processor 1010 may further include a graphics processing unit (GPU) and/or an image signal processor (ISP). The processor 1010 may include at least a portion (e.g., a cellular module 1021) of the elements illustrated in FIG. 10. The processor 1010 may load, on a volatile memory, an instruction or data received from at least one of the other elements (e.g., a nonvolatile memory) to process the instruction or data, and may store various data in a nonvolatile memory.

The communication module 1020 may have a configuration that is the same as or similar to that of the communication interface 970 of FIG. 9. The communication module 1020 may include, for example, the cellular module 1021, a Wi-Fi module 1023, a Bluetooth (BT) module 1025, a GNSS module 1027 (e.g., a GPS module, a GLONASS module, a BeiDou module, or a Galileo module), an NFC module 1028, and a radio frequency (RF) module 1029.

The cellular module 1021 may provide, for example, a voice call service, a video call service, a text message service, or an Internet service through a communication network. The cellular module 1021 may identify and authenticate the electronic device 1001 in the communication network using the SIM 1024 (e.g., a SIM card). The cellular module 1021 may perform at least a part of the functions that may be provided by the processor 1010. The cellular module 1021 may include a CP.

Each of the Wi-Fi module 1023, the BT module 1025, the GNSS module 1027 and the NFC module 1028 may include, for example, a processor for processing data transmitted/received through the modules. According to an embodiment of the present disclosure, at least a part (e.g., two or more) of the cellular module 1021, the Wi-Fi module 1023, the BT module 1025, the GNSS module 1027, and the NFC module 1028 may be included in a single integrated circuit (IC) or IC package.

The RF module 1029 may transmit/receive, for example, communication signals (e.g., RF signals). The RF module 1029 may include, for example, a transceiver, a power amplifier module (PAM), a frequency filter, a low noise amplifier (LNA), an antenna, or the like. According to an embodiment of the present disclosure, at least one of the cellular module 1021, the Wi-Fi module 1023, the BT module 1025, the GNSS module 1027, and the NFC module 1028 may transmit/receive RF signals through a separate RF module.

The SIM 1024 may include, for example, an embedded SIM and/or a card containing the SIM 1024, and may include unique identification information (e.g., an integrated circuit card identifier (ICCID)) or subscriber information (e.g., an international mobile subscriber identity (IMSI)).

The memory 1030 may include, for example, an internal memory 1032 or an external memory 1034. The internal memory 1032 may include at least one of a volatile memory (e.g., a dynamic random access memory (DRAM), a static RAM (SRAM), a synchronous dynamic RAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, and the like)), a hard drive, or a solid state drive (SSD).

The external memory 1034 may include a flash drive such as a compact flash (CF) drive, a secure digital (SD) memory card, a micro-SD memory card, a mini-SD memory card, an extreme digital (xD) memory card, a multimedia card (MMC), a memory stick, or the like. The external memory 1034 may be operatively and/or physically connected to the electronic device 1001 through various interfaces.

The sensor module 1040 may, for example, measure a physical quantity or detect an operational state of the electronic device 1001 so as to convert measured or detected information into an electrical signal. The sensor module 1040 may include, for example, at least one of a gesture sensor 1040A, a gyro sensor 1040B, a barometric pressure sensor 1040C, a magnetic sensor 1040D, an acceleration sensor 1040E, a grip sensor 1040F, a proximity sensor 1040G, a color sensor 1040H (e.g., a red/green/blue (RGB) sensor), a biometric sensor 1040I, a temperature/humidity sensor 1040J, an illumination sensor 1040K, or an ultraviolet (UV) light sensor 1040M. Additionally or alternatively, the sensor module 1040 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 1040 may further include a control circuit for controlling at least one sensor included therein. In an embodiment of the present disclosure, the electronic device 1001 may further include a processor configured to control the sensor module 1040 as a part of the processor 1010 or separately, so that the sensor module 1040 is controlled while the processor 1010 is in a reduced power or sleep state.

The input device 1050 may include, for example, a touch panel 1052, a (digital) pen sensor 1054, a key 1056, or an ultrasonic input device 1058. The touch panel 1052 may employ at least one of a capacitive, a resistive, an infrared, and an ultraviolet sensing method. The touch panel 1052 may further include a control circuit. The touch panel 1052 may further include a tactile layer so as to provide a haptic feedback to a user.

The (digital) pen sensor 1054 may include, for example, a sheet for recognition which is a part of a touch panel or is separate. The key 1056 may include, for example, a physical button, an optical button, or a keypad. The ultrasonic input device 1058 may sense ultrasonic waves generated by an input tool through a microphone 1088 so as to identify data corresponding to the ultrasonic waves sensed.

The display 1060 may include a panel 1062, a hologram device 1064, or a projector 1066. The panel 1062 may have a configuration that is the same as, or similar to, that of the display 960 of FIG. 9. The panel 1062 may be, for example, flexible, transparent, or wearable. The panel 1062 and the touch panel 1052 may be integrated into a single module. The hologram device 1064 may display a stereoscopic image in air using a light interference phenomenon. The projector 1066 may project light onto a screen so as to display an image. The screen may be disposed inside or outside of the electronic device 1001. According to an embodiment of the present disclosure, the display 1060 may further include a control circuit for controlling the panel 1062, the hologram device 1064, and the projector 1066.

The interface 1070 may include, for example, an HDMI 1072, a USB 1074, an optical interface 1076, or a D-subminiature (D-sub) connector 1078. The interface 1070, for example, may be included in the communication interface 970 illustrated in FIG. 9. Additionally or alternatively, the interface 1070 may include, for example, a mobile high-definition link (MHL) interface, an SD card/MMC interface, or an Infrared Data Association (IrDA) standard interface.

The audio module 1080 may convert, for example, sound into an electrical signal or vice versa. At least a portion of the elements of the audio module 1080 may be included in the input/output interface 950 illustrated in FIG. 9. The audio module 1080 may process sound information input or output through a speaker 1082, a receiver 1084, an earphone 1086, or the microphone 1088.

The camera module 1091 is, for example, a device for recording a still image or a video. According to an embodiment of the present disclosure, the camera module 1091 may include at least one image sensor (e.g., a front sensor or a rear sensor), a lens, an ISP, or a flash (e.g., an LED or a xenon lamp).

The power management module 1095 may manage power of the electronic device 1001. According to an embodiment of the present disclosure, the power management module 1095 may include a power management integrated circuit (PMIC), a charger integrated circuit (IC), or a battery gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 1096 and a voltage, current or temperature thereof while the battery 1096 is charged. The battery 1096 may include, for example, a rechargeable battery and/or a solar battery.

The indicator 1097 may display a certain state of the electronic device 1001 or a part thereof (e.g., the processor 1010), such as a booting state, a message state, a charging state, or the like. The motor 1098 may convert an electrical signal into a mechanical vibration, and may generate a vibration or haptic effect. A processing device (e.g., a GPU) for supporting a mobile TV may be included in the electronic device 1001. The processing device for supporting a mobile TV may process media data according to the standards of digital multimedia broadcasting (DMB), digital video broadcasting (DVB), MediaFLO™, or the like.

Each of the elements described herein may be configured with one or more components, and the names of the elements may be changed according to the type of an electronic device. In an embodiment of the present disclosure, an electronic device may include at least one of the elements described herein, and some elements may be omitted or other additional elements may be added. Furthermore, some of the elements of the electronic device may be combined with other electronic devices to form one entity, so that the functions of the elements may be performed in the same manner as before the combination.

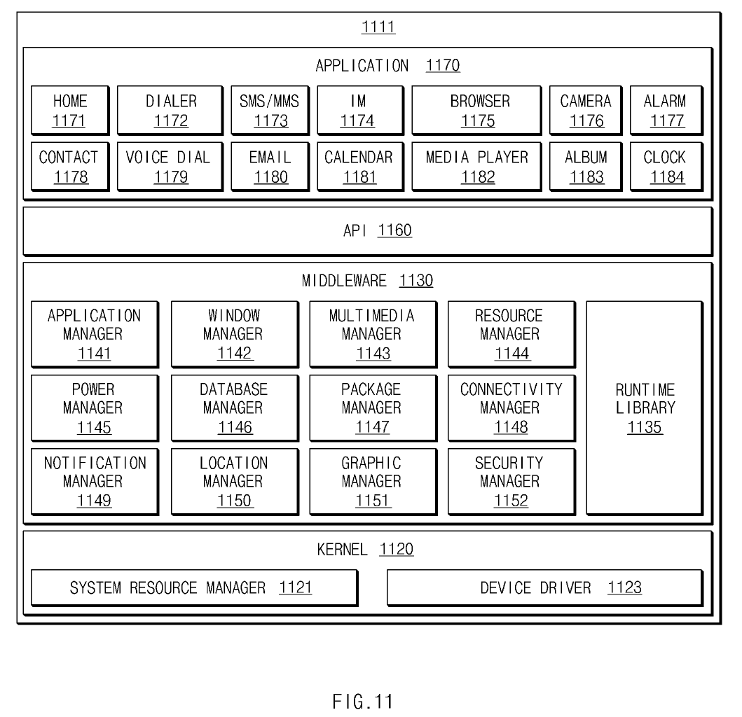

FIG. 11 is a block diagram of a program module 1111 according to an embodiment of the present disclosure.

Referring to FIG. 11, the program module 1111 may include an OS for controlling a resource related to an electronic device and/or various applications running on the OS. The OS may be, for example, Android®, iOS®, Windows®, Symbian®, Tizen®, or the like.

The program module 1111 may include a kernel 1120, middleware 1130, an API 1160, and/or an application 1170. At least a part of the program module 1111 may be preloaded on an electronic device or may be downloaded from the first electronic device 902, the second external electronic device 904, or the server 906 in FIG. 9.

The kernel 1120 may include, for example, a system resource manager 1121 or a device driver 1123. The system resource manager 1121 may perform control, allocation, or retrieval of a system resource. According to an embodiment of the present disclosure, the system resource manager 1121 may include a process management unit, a memory management unit, a file system management unit, and the like. The device driver 1123 may include, for example, a display driver, a camera driver, a BT driver, a shared memory driver, a USB driver, a keypad driver, a Wi-Fi driver, an audio driver, or an inter-process communication (IPC) driver.

The middleware 1130, for example, may provide a function that the application 1170 requires in common, or may provide various functions to the application 1170 through the API 1160 so that the application 1170 may efficiently use limited system resources in the electronic device. According to an embodiment of the present disclosure, the middleware 1130 may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, and a security manager 1152.

The runtime library 1135 may include, for example, a library module that a complier uses to add a new function through a programming language while the application 1170 is running. The runtime library 1135 may perform a function for input/output management, memory management, or an arithmetic function.

The application manager 1141 may mange, for example, a life cycle of at least one application of the application 1170. The window manager 1142 may manage a graphical user interface (GUI) resource used in a screen. The multimedia manager 1143 may recognize a format required for playing various media files and may encode or decode a media file using a codec matched to the format. The resource manager 1144 may manage a resource such as source code, a memory, or a storage space of at least one application of the application 1170.

The power manager 1145, for example, may operate together with a basic input/output system (BIOS) to manage a battery or power and may provide power information required for operating the electronic device. The database manager 1146 may generate, search, or modify a database to be used in at least one application of the application 1170. The package manager 1147 may manage the installation or an update of an application distributed in a package file format.

The connectivity manger 1148 may manage a wireless connection of Wi-Fi, BT, or the like. The notification manager 1149 may display or notify of an event such as a message arrival, appointments, and proximity alerts in such a manner as to not disturb a user. The location manager 1150 may manage location information of the electronic device. The graphic manager 1151 may manage a graphic effect to be provided to a user or a user interface related thereto. The security manager 1152 may provide various security functions required for system security or user authentication. According to an embodiment of the present disclosure, in a case in which an electronic device includes a phone function, the middleware 1130 may further include a telephony manager for managing a voice or video call function of the electronic device.

The middleware 1130 may include a middleware module for forming a combination of various functions of the above-mentioned elements. The middleware 1130 may provide a module specialized for each type of an OS to provide differentiated functions. Furthermore, the middleware 1130 may delete a part of existing elements or may add new elements dynamically.

The API 1160 is, for example, a set of API programming functions that may be provided in different configurations according to an OS. For example, in the case of Android® or iOS®, one API set may be provided for each platform, and, in the case of Tizen®, at least two API sets may be provided for each platform.

The application 1170, for example, may include at least one application capable of performing functions such as a home application 1171, a dialer application 1172, an SMS/MMS application 1173, an instant messaging (IM) application 1174, a browser application 1175, a camera application 1176, an alarm application 1177, a contact application 1178, a voice dial application 1179, an e-mail application 1180, a calendar application 1181, a media player application 1182, an album application 1183, a clock application 1184, a health care application (e.g., an application that measures an amount of exercise or a blood sugar level), or an environmental information provision application (e.g., an application that provides air pressure, humidity, or temperature information).

According to an embodiment of the present disclosure, the application 1170 may include an information exchange application for supporting information exchange between the electronic device (e.g., the electronic device 901 in FIG. 9) and an external electronic device (e.g., the first electronic device 902 or the second external electronic device 904 in FIG. 9). The information exchange application may include, for example, a notification relay application for relaying certain information to the external electronic device or a device management application for managing the external electronic device.

For example, the notification relay application may have a function for relaying, to an external electronic device, notification information generated in another application (e.g., an SMS/MMS application 1173, an e-mail application 1180, a health care application, an environmental information application, and the like) of the electronic device. Furthermore, the notification relay application may receive notification information from the external electronic device and may provide the received notification information to the user.

The device management application, for example, may manage (e.g., install, delete, or update) at least one function (e.g., the turn-on/turn off of the external electronic device (or some elements) or the brightness (or resolution) adjustment of a display) of the external electronic device communicating with the electronic device, an application running in the external electronic device, or a service (e.g., a call service, a message service, and the like) provided from the external electronic device.

According to an embodiment of the present disclosure, the application 1170 may include a certain application (e.g., a healthcare application of a mobile medical device) according to an attribute of the external electronic device. The application 1170 may include an application received from an external electronic device. The application 1170 may include a preloaded application or a third-party application downloadable from a server. The names of the elements of the program module 1111 illustrated may vary with the type of OS.

According to an embodiment of the present disclosure, at least a part of the program module 1111 may be implemented with software, firmware, hardware, or a combination thereof. At least a part of the program module 1111, for example, may be implemented (e.g., executed) by a processor. At least a part of the program module 1111 may include, for example, a module, a program, a routine, sets of instructions, or a process for performing at least one function.

The term “module” used herein may represent, for example, a unit including one of hardware, software, firmware, or a combination thereof. The term “module” may be interchangeably used with the terms “unit”, “logic”, “logical block”, “component” and “circuit”. The term “module” may represent a minimum unit of an integrated component or may be a part thereof. The term “module” may represent a minimum unit for performing one or more functions or a part thereof. The term “module” may represent a device implemented mechanically or electronically. For example, the term “module” may represent a device that includes at least one of an application-specific integrated circuit (ASIC), a field-programmable gate array (FPGA), and a programmable-logic device for performing some operations, which are known or will be developed.

At least a part of devices (e.g., modules or functions thereof) or methods (e.g., operations) according to an embodiment of the present disclosure may be implemented as instructions stored in a non-transitory computer-readable storage medium in the form of a program module. In a case where the instructions are performed by a processor, the processor may perform functions corresponding to the instructions. The non-transitory computer-readable storage medium may be, for example, the memory 930 in FIG. 9.

A non-transitory computer-readable recording medium may include a hard disk, a floppy disk, a magnetic medium (e.g., a magnetic tape), an optical medium (e.g., compact disc ROM (CD-ROM), a digital versatile disc (DVD)), a magneto-optical medium (e.g., a floptical disk), or a hardware device (e.g., a ROM, a RAM, a flash memory, or the like). The program instructions may include machine language code generated by compilers and high-level language code that can be executed by computers using interpreters. The above-mentioned hardware device may be configured to be operated as one or more software modules for performing operations of an embodiment of the present disclosure and vice versa.

A module or a program module according to an embodiment of the present disclosure may include at least one of the above-mentioned elements, some elements may be omitted or other additional elements may be added. Operations performed by the module, the program module or other elements according to an embodiment of the present disclosure may be performed in a sequential, parallel, iterative or heuristic way. Furthermore, some operations may be performed in another order, may be omitted, or other operations may be added.

While the present disclosure has been shown and described with reference to certain embodiments thereof, it will be understood by those skilled in the art that various changes in form and details may be made therein without departing from the scope of the present disclosure. Therefore, the scope of the present disclosure is not intended to be defined as being limited to the embodiments, but is defined by the appended claims and equivalents thereof.

What is claimed is:

1. An electronic device, comprising:
a communication interface configured to communicate with an external electronic device;
a memory configured to store a plurality of answers;
a display;
an input interface configured to acquire a user input; and
a processor operatively connected to the communication interface, the memory, the display, and the input interface,
wherein the memory is configured to store instructions that, when executed, cause the processor to:
receive a message from the external electronic device through the communication interface;
analyze the received message;
select at least one of the plurality of answers according to a type of a keyword included in the received message or context of the received message;
output the at least one of the plurality of answers on the display; and
change a portion of a first answer of the at least one of the plurality of answers if a first user input is acquired through the input interface.

2. The electronic device of claim 1, wherein the input interface includes at least one of:
a rotating member included in a bezel disposed in a portion of a housing of the electronic device;
a stem disposed in the housing;
a physical key disposed in the housing; and
a touch panel included in the display.

3. The electronic device of claim 2, wherein the first user input occurs by at least one of an operation of rotating the rotating member, pressing the physical key, rotating the stem, pressing the stem, and touching the display.

4. The electronic device of claim 3, wherein the memory is further configured to store instructions that, when executed, cause the processor to:
change the portion of the first answer differently based on at least one of a rotation amount of the rotating member, a number of times that the physical key is pressed, a rotation amount of the stem, a number of times that the stem is pressed, and touch information of the display.

5. The electronic device of claim 1, wherein the memory is further configured to store instructions that, when executed, cause the processor to:
determine at least one changeable portion of the first answer;
highlight the portion of the first answer, wherein the portion of the first answer is a portion of the at least one changeable portion of the first answer; and
change the highlighted portion of the first answer in response to the first user input.

6. The electronic device of claim 5, wherein the memory is further configured to store instructions that, when executed, cause the processor to:
output the highlighted portion of the first answer differently from another portion of the first answer in a manner of applying a graphical effect to the highlighted portion of the first answer when outputting the first answer on the display.

7. The electronic device of claim 5, wherein the memory is further configured to store instructions that, when executed, cause the processor to:
release highlighting of the highlighted portion of the first answer if a second user input is acquired through the input interface; and
highlight another portion of the at least one changeable portion of the first answer or highlight a portion of a second answer, which is different from the first answer, of the at least one of the plurality of answers.

8. The electronic device of claim 5, wherein the at least one changeable portion of the first answer includes:
at least one of a word indicating time, a word indicating a date, a word indicating a day, a word indicating a location, a postposition, and an ending.

9. The electronic device of claim 1, wherein the memory is further configured to store instructions that, when executed, cause the processor to:
change at least one of the plurality of answers stored in the memory if a second user input is acquired through the input interface.

10. The electronic device of claim 1, wherein the memory is further configured to store instructions that, when executed, cause the processor to:
transmit the first answer to the external electronic device through the communication interface.

11. A method of providing an answer by an electronic device including a memory storing a plurality of answers, the method comprising:
receiving a message from an external electronic device connected to the electronic device through a communication interface;
analyzing the received message;
selecting at least one of the plurality of answers according to a type of a keyword included in the received message or context of the received message;
outputting the at least one of the plurality of answers on a display included in the electronic device;
acquiring a first user input through an input interface included in the electronic device; and
changing a portion of a first answer of the at least one of the plurality of answers in response to the first user input.

12. The method of claim 11, wherein the input interface includes at least one of a rotating member included in a bezel disposed in a portion of a housing of the electronic device, a physical key disposed in the housing, a stem disposed in the housing, and a touch panel included in the display.

13. The method of claim 12, wherein the first user input occurs by at least one of an operation of rotating the rotating member, pressing the physical key, rotating the stem, pressing the stem, and touching the display.

14. The method of claim 13, wherein changing the portion of the first answer comprises:
changing the portion of the first answer differently based on at least one of a rotation amount of the rotating member, a number of times that the physical key is pressed, a rotation amount of the stem, a number of times that the stem is pressed, and touch information of the display.

15. The method of claim 11, further comprising:
determining at least one changeable portion of the first answer; and
highlighting the portion of the first answer, wherein the portion of the first answer is a portion of the at least one changeable portion of the first answer,
wherein changing the portion of the first answer comprises changing the highlighted portion of the first answer.

16. The method of claim 15, wherein outputting the at least one of the plurality of answers on the display comprises:
outputting the highlighted portion of the first answer differently from another portion of the first answer in a manner of applying a graphical effect to the highlighted portion of the first answer when outputting the first answer on the display.

17. The method of claim 15, further comprising:
releasing highlighting of the highlighted portion of the first answer if a second user input is acquired through the input interface; and
highlighting another portion of the at least one changeable portion of the first answer or highlighting a portion of a second answer, which is different from the first answer, of the at least one of the plurality of answers.

18. The method of claim 15, wherein the at least one changeable portion of the first answer includes:
at least one of a word indicating time, a word indicating a date, a word indicating a day, a word indicating a location, a postposition, and an ending.

19. The method of claim 11, further comprising:
changing at least one of the plurality of answers stored in the memory if a second user input is acquired through the input interface.

20. The method of claim 11, further comprising:
transmitting the first answer to the external electronic device through the communication interface.
